(19) United States
(12) Patent Application Publication
(10) Pub. No.: US 2026/0083068 A1
(43) Pub. Date: Mar. 26, 2026

(54) METHOD AND CULTIVATION ASSEMBLY OF CULTIVATING INDETERMINATE PLANTS

(71) Applicant: Saia Holding B.V., Ede (NL)

(72) Inventors: Ruud Barth, Driebergen-Rijsenburg (NL); Bart Adrianus Johannes van Tuijl, Doesburg (NL)

(21) Appl. No.: 19/110,937

(22) PCT Filed: Oct. 27, 2023
(86) PCT No.: PCT/EP2023/080095

§ 371 Date: Mar. 12, 2025

(30) Foreign Application Priority Data
Oct. 31, 2022 (NL) 2033431

(51) Int. Cl. A01G 9/14

(52) U.S. Cl. CPC A01G 9/143

(57) ABSTRACT

A method of cultivating indeterminate plants, for example tomato plants, bell pepper plants, cucumber plants and/or eggplants, that are suspended from an overhead conveyor device, in a cultivation area of an indoor farming location with multiple growing zones, e.g. in a greenhouse, a vertical farm or a climatized warehouse, includes the steps of: scanning one or more parameters of the plants with a scanning device arranged in a central operating area of the farming location, characterizing the plants into multiple different harvest readiness stages on the basis of the scanned parameters, moving the plants towards the cultivation area, and sorting of plants into the multiple growing zones on the basis of their harvest readiness stage, where the plants are sorted in a number of groups, and where each group of sorted plants is moved into a respective growing zone.

### CROSS-REFERENCE TO RELATED APPLICATIONS

This application is the National Stage of International Application No. PCT/EP2023/080095, filed Oct. 27, 2023, which claims the benefit of Netherlands Application No. 2033431, filed Oct. 31, 2022, the contents of which is incorporated by reference herein.

### FIELD OF THE INVENTION

The present invention relates to a method of cultivating indeterminate plants that are suspended from an overhead conveyor device, in multiple growing zones in an indoor farming location. The present invention further provides a cultivation assembly for cultivating plants.

### STATE OF THE ART

In an aim to reduce costs for cultivating plants, it has become a recent trend to reduce the amount of labour required. To this effect, several tasks are automated that initially relied on manual labour. Examples thereof are the harvesting of produce from the plant or the removal of excess leaves that are no longer required or functional for photosynthesis, but do absorb growing energy that otherwise could go to the produce yield.

Several automated robots have been introduced that are able to travel through the greenhouse, for example to ride along the plants. Especially when indeterminate plants are cultivated, the plants are typically provided in various harvesting stages, being randomly arranged at different harvest readiness stages. The robots must ride along all plants, to detect produce that is ready to be harvested and to harvest the produce.

Although these mobile robots are able to perform tasks automatically that were manual before, thus forming an improvement relative to manual labour, are the robots relatively and slow and not effective, because of the poor visibility and reachability of the dense crops. Furthermore, they are complex, because they both require propulsion to move through the indoor farming location and need a robot arm or the like to perform the tasks. Furthermore, in case the robot is for example used for harvesting produce, an entire mobile logistics chain needs to be established to transport the produce away from the robot for packaging or the like.

NL 9 201 632 A discloses a method and system of growing indeterminate plants, which are cultivated in a vertically suspended container with a grid-like trellis frame and which can be moved between a plurality of cultivating tracks in a greenhouse and a centralized scanning and harvesting device, where the containers are rotated to be aligned horizontally, to have the produce downwardly suspended from the trellis frame.

In WO 2022/061288 A1 discloses a system where plants, e.g. strawberry plants, are cultivated in suspended towers with multiple plant containers arranged above each other. The system comprises a height adjustable harvesting device to be able to harvest produce from each of the plants, i.e. at each of the container levels.

Furthermore, US 2022/046875 A1 discloses a similar arrangement, having movable hydroponic grow tower assemblies that are suspended from an overhead conveyor system. The system further comprises a movable manipulator arm for manipulating the plants.

### OBJECT OF THE INVENTION

It is therefore an object of the invention to provide a method of cultivating indeterminate plants that may reduce manual labour and that may lack one or more of the above drawback, or at least to provide an alternative method of cultivating plants.

### DETAILED DESCRIPTION

According to a first aspect, the present invention provides a method of cultivating indeterminate plants, for example tomato plants, bell pepper plants, cucumber plants and/or eggplants, that are suspended from an overhead conveyor device, in a cultivation area of an indoor farming location with multiple growing zones, e.g. in a greenhouse, the method comprising the steps of:
scanning one or more parameters of the plants, e.g. of produce of the plants, with a scanning device arranged in a central operating area of the farming location,
characterizing the plants into multiple different harvest readiness stages on the basis of the scanned parameters,
moving the plants towards the cultivation area, comprising sorting of plants into the multiple growing zones on the basis of their harvest readiness stage.

The plants may be sorted in a number of groups, for example corresponding to the number of growing zones, and wherein each group of sorted plants may be moved into a respective growing zone.

According to the present method, the plants themselves are mobilized. In this way, the plants travel inside an indoor farming location, between the cultivation area and the central operating area. The indoor faming location may especially be a greenhouse, or alternatively a vertical farm or a climatized warehouse. In the following, any reference to an indoor farming location may refer to a greenhouse and any reference to a greenhouse may refer to any type of indoor farming location.

In the cultivation area, the plants are allowed to grow and receive water and/or nutrients, whilst being illuminated. However, the present method does not require certain acts, like harvesting, trimming an pruning, to be carried out where the plants are allowed to grow. Instead, these acts are carried out in the central operating area, where dedicated equipment may be arranged stationary.

The present method is directed at the cultivation of indeterminate plants, which are plants that continue to grow during a growth season and die off in winter, in the absence of a climatized environments. These plants grow produce that does not ripen all at once, like with determinate plants, but rather continuously. New produce will start to grow continuously, while older produce ripens to become ready for harvesting.

Determinate plants have multiple meristems where the plants grow, without any preference. During bloom, all meristems stop growing, to develop all produce simultaneously. Indeterminate plants also have multiple meristems, but only one thereof is dominant, at which the plants continues to grow. As such, the indeterminate plant is able to grow new produce continuously and may obtain a relatively long stem. These indeterminate plants can lay on the ground or can be suspended from above. Over the length of the stem, these indeterminate plants can contain produce and leaves in various different stages of growth, for example having young produce at a top end and having produce that is ready to be harvested at the bottom.

Examples of indeterminate plants, that can be cultivated with the present method, are tomato plants, bell pepper plants, cucumber plants and/or eggplants. However, also peppers, beans, vanilla, melons, bitter melons and passion fruits can be cultivated this way. These plants may typically grow vertically upwards along a wire that is suspended from the ceiling of the greenhouse and typically have a large stem length. Normally, these plants are difficult to handle, due to the large stem length. However, the present method does enable convenient moving of these long stem plants.

According to the present invention, the plants are suspended from the overhead conveyor device, which may be any type of device able to transport the plants through the greenhouse. The plants may be suspended directly, for example from their own stem, or may grow in a support structure, like a container supported from the overhead conveyor device. This overhead conveyor device may be suspended from a ceiling of the greenhouse and extends through the cultivation area and the central operating area of the greenhouse.

The overhead conveyor device extends through the central operating area, i.e. along a scanning device and optionally a harvesting device, and through the cultivation area. The cultivation area thereby comprises multiple growing zones, in each of which the conveyor device is provided. Accordingly, the conveyor device is able to move the plants between each of the growing zones and the central operating area.

As a first step, the present method comprises the step of scanning of one or more parameters of the plants. These plant parameters may provide information about a status of the plant, for example the size of the plant, but especially about the status of the produce of the plants. The plant parameters may for example involve information about the ripeness and/or size of the produce of the plant. The step of scanning is carried out with a scanning device that is arranged in the central operating area, whereas the prior art still relied on scanning, i.e. with a mobile robot, in the cultivation area.

On the basis of the plant parameters, the plants are characterized into the multiple different harvest readiness stages. This characterization may sort the plants into different groups, for example depending on the ripeness or harvest-readiness of the produce. In any case, the harvest readiness stage represents the actual state of the plant relative to a desired state, in which the plant is ready for harvesting.

The harvest readiness stage of the plants, in particular the time remaining until produce can be harvested, may be determined on the basis of the heat sum of the plants. The heat sum may be defined as an accumulated time-dependent difference between the actual temperature in the greenhouse and a certain threshold temperature, for example expressed in degrees Celsius. The heat sum may be formed by the daily temperature difference multiplied by the number of days.

After harvesting of the produce, a new heat sum will need to elapse before subsequent produce can be harvested from the same plant. For example, the actual in the greenhouse may be 30° C. and the threshold temperature may be 10° C. Each day thereby contributes 20° C. to the heat sum. Should the heat sum of a certain type of produce for example amount 200° C., then the number of days between harvesting of subsequent pieces of produce will be approximately in the range between 6 and 10 days.

The harvest readiness stages may represent the number of days remaining until the next piece of produce can be harvested. Depending on the type of plants, the harvest readiness stages can span more than a single week, or even less, for example a number of days.

Alternatively or additionally, the harvest readiness stage may be a binary parameter, which may indicate whether or not harvest of produce is required for a certain plant. As such, the present method may provide that a plant in need of harvesting can be moved towards a harvesting device and that a plant with produce not ready for harvesting is kept in or moved back into the cultivation area.

After the step of characterizing, the plants can be moved towards the cultivation area directly. However, the plants are not merely moved into the cultivation area in the same order as they are scanned. Instead, the plants are sorted over the multiple growing zones, so that different plants at the same or at a similar harvest readiness stage, end up in the same growing zone.

The sorting of the plants results in a number of groups of sorted plants, that may correspond to the number of growing zones, so that each group of sorted plants is moved into a respective growing zone upon movement into the cultivation area. The number of groups of sorted plants may also differ from the number of growing zones, for example where a single group of sorted plants is moved towards multiple growing zones, or where a single growing zone will receive multiple different groups of plants.

Prior to the step of scanning, the plants could have be randomly arranged in the greenhouse, whereas the present method will effect sorting of the plants over the growing zones. However, the scanning and characterizing of the plants is preferably carried out each time that the plants are retrieved from their growing zones, thus not necessarily only at the beginning but also over the course of their growth.

The number of growing zones in the greenhouse may correspond to the total number of harvest readiness stages in which the plants can be characterized. In this case, each growing zone receives plants that are at a single harvest readiness stage. However, should there be more harvest readiness stages than growing zones, plants with different harvest readiness stages can be grouped in a single growing zone. In case there are, oppositely, more growing zones than harvest readiness stages, multiple growing zones can receive plants that are at the same harvest readiness stage. The latter may be the case with the binary harvest readiness stage, i.e. whether a certain plant is now ready for harvesting or not, so that a relatively large number of plants not ready for harvesting can be held in multiple growing zones and that a relatively small number of plants ready for harvesting can be moved into a single growing zones after sorting.

The growing zones in the cultivation area may, but not need to, be provided in separate compartments in the cultivation area. However, the growing zones may alternatively each be defined as a separate side track of the conveyor device, which side tracks are then all provided in the same cultivation area. Each of the growing zones may have different setpoint values for climate, light, watering and nutrient conditions.

The sorting of the plants may involve grouping the plants, wherein each group of plants may comprise multiple plants that are interconnected. During sorting, plants at the same or similar harvesting stage can be assigned to the same group, in order to be moved towards the same growing zone in common. This may be beneficial, since not all plants need to be moved individually, but that all plants in the group can be moved in common instead. The sorting of the plants may be carried out in the respective growing zones directly, so that each plant is individually moved towards its respective growing zone, or the plants may be accumulated in buffer sections in the central operating area, wherein, once filled, the buffer sections can be emptied in one go and the respective plants can be transported towards a growing zone simultaneously.

The sorting of the plants may, however, not be done on the basis of the harvest readiness stage exclusively, but also on other parameters. For example, in case a large demand for produce is foreseen, the sorting may also be done on the basis of the demand. For example, one or more of the growing zones may then be subjected to a different climate, so that the harvesting moment for those plants can be advanced or postponed.

The present method provides plants that are sorted in different growing zones. In case it is needed to harvest produce from the plants, it is no longer necessary to check the harvest readiness for all plants in the cultivation area, as is the case with the present mobile robots. Instead, only the plants from a certain growing zone, having a certain harvest readiness stage need to be moved towards the harvesting device. The other plants are not yet ripe for harvesting, so that they can remain in the cultivation area, without being moved. It is known that movement of plants induces stress in the plants, reducing productivity. The present method does not require movement of plants that do not need to be harvested, and therefore allows for an improved productivity, and/or a more uniform spacing of the plants over the growing area for optimal light interception and distribution of microclimates.

The method according to the present invention offers multiple benefits. For example, the plants can be located closer to each other in the cultivation area, since it is no longer mandatory to have robots travelling in between them. This may offer an increased amount of plants per unit of area, and thus allows for improved productivity.

Furthermore, the scanning of plant parameters can also be carried out more accurately, since the plants can be moved away from each other. In the prior art, with the stationary plants, there was a risk that during scanning of plant parameters not only parameters of the intended plant were scanned, but also of other plants. For example, the scanning device could detect ripe produce on another plant and would falsely assign the ripe produce to the wrong plant. According to the present invention, the plants can be isolated from each other, in terms of scanning, to improve the reliability thereof.

Moreover, the present method may also allow for exact tracking and tracing of individual plants and their historic plant parameters, coupled to the history of their positions in the growing areas and coupled to the history of plant maintenance operations.

Finally, the logistics of, for example, the harvesting device can be improved. In case of the mobile harvesting robot, it was required for the robot to take along all harvested produce. This could form a limitation on the productivity and could also increase downtime, since the robot might needed to exchange a full produce storage with an empty one. According to the present method, instead, the harvested produce can be accumulated easily alongside the stationary harvesting device. Furthermore, the moving robots anyhow needed to visit and sense each plant, regardless of its harvest readiness level, because plants were growing in a randomly arrangement and are, currently, not tracked and traced.

The present method can be repeated several times during the growth of the plants. For example, the plants can be sorted for the first time, as they could have been arranged randomly in the greenhouse before or as they could have been fed into the greenhouse randomly. However, the scanning and sorting may be repeated over time, so that, in case variations in harvest readiness stage occur between plants in a growing zone, the plants can be re-sorted according to their new harvest readiness stage.

The present method may allow simultaneous cultivation of multiple different types of plants in the same greenhouse, for example allowing simultaneous cultivation of tomato plants and cucumber plants. The sorting of the plants into multiple growing zone may also comprise sorting per type of plants so that, for example, all tomato plants are moved into a plurality of first growing zones and that all cucumber plants are moved into a plurality of second growing zones. The method according to the present invention therefore allows for more flexible cultivation of produce.

In an embodiment, the plant parameters comprise one or more of a colour of the produce, a texture of the produce, a shape of the produce, a size of the produce, a chemical composition of the produce, in particular a sugar content thereof, a fluorescence of the produce, in particular a chlorophyll fluorescence, and/or hyperspectral colour bandwidths thereof, and/or a plant identifier.

The colour of the produce may represent the ripeness of the produce. For example, ripe tomatoes may have a red colour, whereas unripe tomatoes may still have a green colour. By determining the colour of the tomatoes, their harvest readiness stage can be determined.

The same may apply for the texture, which can change in dependence of the ripeness. This may happen with cucumbers, for example, which initially may have a relatively rough texture, which becomes more smooth as the cucumbers ripen.

The shape and size of the produce may also form an indication for the ripeness and harvest readiness stage. Hence, the produce will grow over time, until a certain desired size or shape is reached. The shape and size of the produce are representative for the weight of the produce, which is an important parameter for determining the harvest-readiness of the produce.

Furthermore, in case the plants are sorted on a plant parameter that represents the size of the produce, the harvested produce may have more uniform dimensions, as compared to when all plants were to be harvested randomly. The uniform produce size may have a larger economical value on the market.

The scanning of the plant parameters may involve determining a chemical composition of the produce, in particular a sugar content thereof. The sugar content may also be representative for the ripening of the produce, although not being visible for the human eye. Instead, the sugar content may be determined by means of hyperspectral imaging. This may render the present method more accurate than existing ways of harvesting produce manually, since a human worker is not able to determine sugar contents of the produce, i.e. without tasting it.

Similarly, the fluorescence of the plant or the produce may be determined, in particular a chlorophyll fluorescence. The chlorophyll fluorescence may be representative for the photosynthesis taking place in the plant, resp. in the produce, so that an objective estimation of the state of the plant, resp. the produce can be obtained.

As a further alternative, the plant parameters may be included in a plant identifier associated with the plant. The identifier may be composed of a wireless beacon, such as an RFID-tag, that is associated with a specific plant, so that the scanned parameters can be associated to that specific plant.

All the above plant parameters may also be used in combination for characterization of the plants, for example in case multiple pieces of produce are located next to each other, such as with a truss of tomatoes. The harvest readiness stage can then be determined based on the number of tomatoes in a truss that has been coloured. Furthermore, the scanning of multiple different plant parameters may also yield a number of produce pieces that belong to each other. In this way, it may be prevented that only a single tomato is harvested from a truss, where it would be preferable to have the entire truss harvested in one go.

In an embodiment, the scanning device is an optical scanning device and wherein step of the scanning comprises:
obtaining one or more images of the plants, e.g. of the produce of the plants, and
processing the images to deduct the plant parameters from the images.

The optical scanning may be an efficient manner of determining plant parameters, since images of the produce may contain information about the colour, texture, shape and size of the produce. However, the images themselves may only contain the information of the plant parameters implicitly, i.e. as colours and contrasts. By processing of the images, the plant parameters are deducted from the images, to be used for characterization of the harvest readiness stage.

Alternatively, the scanning device may be a 3D scanning device, configured to obtain three-dimensional images of the plants, especially of the produce. Alternatively, the scanning device may be a laser line detector, configured to deduct a shape of the produce on the basis of selective reflections of a linear laser beam on the produce, as the plants move across the laser beam.

In an embodiment, the harvest readiness stage represents a predicted growing period remaining until at least part of the produce is ripe and/or until harvesting of the at least part of the produce is desired. According to this embodiment, the sorting of the plants into the multiple different growing zones is done on the basis of a predicted time remaining before harvesting.

The remaining time for harvesting can be determined on the basis of the ripeness of the produce, for example a percentage of the ripeness of the produce or for the ripeness per piece or group of produce. For example, the scanning may involve the determining of the ripeness of several of the lowermost pieces of produce of a plant, e.g. lowermost trusses of tomatoes, that typically need to be harvested first. In this case, the harvest readiness stage may represent a time period remaining before the lowermost pieces of produce are ripened to a desired extent.

The harvest readiness stage can also be assigned on the basis of a desired harvesting period, for example in case a certain demand is foreseen at a certain moment in the future. In this case, the harvest readiness stages can be selected such, that the desired amount of produce can be harvested at the desired moment. The plants can thereby be sorted that all plants that together contain this amount of produce are accommodated in a single growing zone.

Depending on the expected demand, one or more of the growing zones can be filled with more or fewer plants and/or may have a different plant density than other growing zones. The number of plants in one or more of the growing zones may thereby be tailored to the projected demand, to have a desired amount of produce at the intended moment of harvesting. The present method may thereto involve a balancing algorithm configured to take distributions of harvest readiness stages of the plants and to re-assign individual plants optimally into other growing zones, in order to speed up or slow down the growth of individual plants, thereby creating a new overall distribution of harvest readiness stage amongst all plants.

In an embodiment, the step of sorting may comprise exchanging plants between adjacent exchange sections of the overhead conveyor device. As such, the order of suspension of the plants can be changed, so that plants at similar harvest readiness stages can be grouped together. The displacement directions of the plants at the adjacent exchange sections may be aligned opposite to each other, so that all plants pass each other at an interface between the adjacent exchange sections. As such, a plant travelling in one direction in a first one of the adjacent exchange sections can be transferred to an empty slot in a second one of the adjacent exchange sections, travelling in an opposite direction.

In a further embodiment, the method further comprises, after the predicted growing period of plants in a respective growing zone has elapsed, the steps of:
moving the plants from that growing zone towards the central operating area,
harvesting the produce from the plants with a harvesting device arranged in the central operating area, and
moving the plants back towards their growing zone.

According to this embodiment, a group of sorted plants in a growing zone is moved towards the central operating area as soon as the plants were allowed to grow for a period corresponding to the predicted growing period and after the predicted growing period has elapsed. The plants have thus been accommodated in the growing zones after the step of characterizing. At the predicted harvesting moment, only those plants are moved that are expected to have ripened produce. The other plants, i.e. in other growing zones, are not expected to have any ripened produce and can remain in the cultivation area, in order not to induce stress and to minimize wear of mechanical device components by unnecessary movement. The moving of the plants may be effected by the overhead conveyor device, which may be configured to selectively only retrieve plants from the growing zone of which the predicted growing period has elapsed, without requiring movement of the plants suspended from the overhead conveyor device in the other growing zones.

After being moved into the central operating area, the plants are passed along the harvesting device, where the ripened produce is removed from the plants. The harvesting device may further remove redundant leaves from the plants. The harvested produce is passed on for further processing, such as washing, weighing and packaging. The plants themselves are moved back towards the growing zone from which they are obtained, to allow them to grow further and to develop new produce. Also on their way back towards the growing zone, the plants may be moved with the overhead conveyor device.

Optionally, the plants may be moved along the scanning station after harvesting, to re-determine the harvest readiness stage for the plants of which the produce was harvested. By re-determining the harvest readiness stage, the harvest readiness stage can be set in a feedforward manner. In this way, a subsequent harvesting moment for these plants is predicted not requiring any further scanning, which may further reduce the movement of the plants.

Alternatively or additionally, the plants may be passed along other automation stations and/or human stations for additional plant maintenance.

In an embodiment, the method comprises, in case the harvest readiness stage of a plant represents that the produce is ripe and/or that harvesting of the at least part of the produce is desired,
moving the plant towards the harvesting device,
harvesting the at least part of the produce from the plants with a harvesting device arranged in the central operating area, and
moving the plants back towards their growing zone.

According to this embodiment, the step of harvesting may take place after the characterizing and preferably directly after the characterizing, thus without moving the plants into the growing zones in between. During characterizing, the harvest readiness stage may be determined as the binary parameter that is described above, to represent whether harvest of produce is required for a certain plant at that time. Should harvesting be necessary, the plants are moved directly towards the harvesting device, without returning to the growing zones first. Only after harvesting, the plants are moved back towards their growing zones.

Especially, all plants from the harvesting device may be returned to the same growing zone, since they need to be retrieved for subsequent harvesting after about the same time.

This embodiment of the method provides the benefit that the harvesting is carried out directly after the characterizing, which means that the determined harvest readiness stage is very accurate at the time of harvesting.

In a further embodiment, the method further comprises, after the step of harvesting, the step of accumulating harvested plants, wherein the moving of the plants comprises moving the accumulated harvested plants towards a single growing zone.

According to this embodiment, all plants from the harvesting device are accumulated into a group. For example, all these plants may be entered into a buffer section so that the plants can be grouped and moved into their growing zone, i.e. a single growing zone, as a group. This makes handling of the plants more conveniently, since all plants at the same harvest readiness can be moved in common in their group.

All plants that do not undergo harvesting may be sent towards their growing zones directly, or may also be grouped so that eventually at least two groups of plants are obtained, i.e. a group consisting of plants that underwent harvesting and a group consisting of plants that did not undergo harvesting.

Alternatively, the accumulating may be carried out after the step of characterizing, thus prior to the harvesting. As such, the group of plants for which harvesting is deemed necessary may be guided along the harvesting device, whereas the group for which harvesting is not needed can be returned to its growing zone.

In an embodiment, the method comprises the step of spreading adjacent plants at the scanning device and/or the harvesting device to locally increase a mutual distance between subsequent plants.

The spreading may involve moving the bottom portions of the plants away from each other, whereas the top portions, i.e. from which the plants are suspended, can remain in place. When a certain central plant is arranged in the scanning device and/or the harvesting device, an upstream neighbouring plant and a downstream neighbouring plant may be spread away from the central plant, in order to increase the amount of space around the central plant. This may, for example, improve the quality of scanning of the central plant, because the risk of inadvertently scanning another plant is reduced. Furthermore, the harvesting may be done more convenient, because the risk of inadvertent contact with the neighbouring plants is reduced.

In a further embodiment, the method may comprise the step of temporarily storing one or more of the plants in one or more buffer sections, in dependence from the harvest readiness stage of the plants.

The buffer sections are preferably located in the central operating area and serve the purpose of temporarily storing the plants, for example after they are retrieved from the cultivation area and prior to being returned to the cultivation area. The buffer sections can contribute in the sorting of the plants, i.e. after the scanning and the determining of the plant parameters or after the harvesting, by temporarily holding a plant.

The buffer sections may be used to temporarily accumulate plants that are intended to be fed in one of the growing zones. For example, one buffer section may be filled with plants that underwent harvesting, whereas other plants, that did not undergo harvesting, can be returned to the cultivation area directly. The buffer section may be temporarily filled with the plants, until the number of plants corresponds to the intended number of plants for a certain growing zone. Then, the entire buffer section can be emptied to field all plants in the growing zone in one go.

The number of buffer sections may be selected on the basis of a desired number of groups of plants. For example, one buffer section may be reserved for plants that underwent harvesting, wherein another buffer section may be reserved for plants that were lowered and/or wherein yet another buffer section may be intended for plants that were just scanned, but which did not require harvesting. This may allow that each group of plants can be accumulated in a dedicated buffer section and that the entire buffer section with all plants can be emptied in one go and can be transported towards a growing zone.

The buffer sections may, but not necessarily need to, form a side track of a main path for the plants between the cultivation area and the central operating area. As such, the plants can be temporarily stored, for example prior to or after scanning and/or prior to or after harvesting. When the buffer section is provided as a side track, the plants can be moved temporarily out of the main path of the plants, for example a main path in the main conveyor section, extending in between the cultivation area and the central processing area. The main path may thereby be formed by the main conveyor section along which the plants are moved between the cultivation area and the scanning device, the scanning device and the harvesting device, and/or between the harvesting device and the cultivation area. By means of the side track, the buffered plants can be moved out of the way of the other plants temporarily so that the other plants can be passed while the buffered plants are bypassed.

In an embodiment, the plants comprise a stem and a root portion, wherein the suspended plants freely hang by a top portion of the stem, and wherein the root portion hangs from the stem, e.g. freely hangs from the stem, in a substantially enclosed root compartment in the absence of growth medium.

According to this embodiment, the plants can be grown continuously and hang substantially straight and vertically. The plants are freely suspended, which implies that substantially the entire plant hangs under the influence of gravitational forces, i.e. thus hanging substantially vertical, without resting at least partially horizontally and without being arranged in any type of root growth medium and preferably without the root portion being supported separately by a root compartment. The free suspension of the plant yields that the plant substantially fully supports its own weight. Hence, all parts of the plant below the top portion are fully hanging from the top portion, without being substantially supported otherwise in the vertical direction.

The plants comprise a stem, which can be defined as the part of the plant that is substantially free of roots and rather has produce and leaves attached to it, and a root portion, which can be defined as the part comprising roots. The root portion may be located in the root compartment during growth of the plants in the cultivation area, whereas the stem is located outside, e.g. above, the root compartment. This embodiment is in particular effective for the cultivation of plants with a stem that is relatively long compared to the length of the plants root portion, like tomato plants, bell pepper plants, cucumber plants and/or eggplants, and plants the like that are able to form roots on stem parts under certain conditions like humidity, low light level and oxygen level.

The root portion of the plant is suspended in the root compartment, which is substantially closed-off from the surroundings, for example only comprising a single opening at a top end through which the plant may extend. The root compartment is substantially empty, which implies that the plant's roots are not arranged in any type of growth medium, like soil, rock wool or the like, but instead that the plant's roots freely hang in the air inside the root compartment.

In the root compartment, water with nutrients may be supplied to the plant's roots. This supply of nutrients may involve supplying water, i.e. combined with nutrients, oxygen and fertilizer etc., so that they can be absorbed by the roots. The supplying may involve spraying of water with nutrients onto the root portion, wherein the spraying may rely on droplets with various sizes, varying from a small droplet size, in which the spraying effectively becomes misting or generation of a fog, to a large droplet size, for example to effect a certain degree of direct penetration of the plant with water.

Alternatively, the watering may involve submerging, in particular temporarily submerging, of the root portion in a body of water with nutrients. In addition to the submerging, oxygen may be actively fed into the body of water, for example by means of bubbling, to provide for additional oxygen and turbulence to the submerged root portion. As a further alternative, the watering may involve dripping of the root portion, for example by discharging droplets of water into an inner volume of a root growth promotor that is filled with the root portion.

The present embodiment provides the advantage that the footprint of the plant can be significantly smaller than that of the plants in the prior art, which may reduce the risk of entanglement of roots of two adjacent plants, because each root portion is only located below the stem and not extending sideways substantially.

Furthermore, the present embodiment offers the advantage that the plants can be transported through the surroundings, e.g. the greenhouse, with great convenience. Hence, the plants only hang straight below a support structure and have free hanging root portions that are not located in voluminous and heavy plant pots or substrates. Furthermore, the plants are not attached to the root compartment, but solely hang therein. In the absence of such attachment, it is thus not necessary, when it is desired to move the plant around, to undo a support of the root portion inside the root compartment or to uncouple the root portion from a loop wire extending through the root compartment, like in the prior art.

Alternatively, the plants are suspended from the overhead conveyor device by means of a support structure. The support structure may, for example, comprise a container with soil that is suspended from the overhead conveyor device. Each of the plants may be arranged in the soil in a container with its root portion, so that the plants can grow from the soil and that the soil can be watered, to feed water and nutrients to the plants. The plants are thereby suspended from the overhead conveyor device indirectly, via the support structure.

In a further embodiment, the method further comprises the steps of:
lowering the plant, in the central operating area, by re-suspending the plant by a newly-grown portion of the stem, i.e. above the top portion of the stem, and,
pruning the root portion of the plant at least partially at a bottom end thereof, in the central operating area.

The steps of lowering and root pruning preferably take place after harvesting of the produce and/or leaf removal, i.e. when produce and/or leaves are removed from the lowermost portion of the stem. The lowering may be carried out manually or automatically, for example by means of an automated lowering device. By lowering, it is meant that the plant's suspension is changed, so that the plant will come to hang lower.

The root pruning may be carried manually or automatically, but is, within the meaning of the present invention, always carried out as an active step during which part of the root portion is removed. This active step differs, for example, from prior art growing methods, in which a bottom portion of the roots was supposed to die off, i.e. in the absence of water, and only being cut off afterwards.

Only after lowering and pruning, following the step of harvesting and optionally other steps for plant maintenance, the plant may then be moved back towards the growing zone. These steps of lowering and pruning may be repeated after a subsequent harvesting action, i.e. after the plant was allowed to grow further inside the cultivation area. In this way, the plant is allowed to continuously ‘refresh’ itself, while having a length, e.g. a combined length of the stem and the root portion, that is substantially the same each time the plant is lowered and pruned.

In an embodiment, the method further comprises the step of adjusting the growth conditions, for example temperature, watering, supply of nutrients and/or lighting conditions, in each of the growing zones in dependence of the harvest readiness stage of the plants in that growing zone.

With all plants sorted between the growing zones, it is no longer necessary to have a global climate in the greenhouse that suits all plants. Instead, the climate may be adjusted for each of the growing zones, so that the climate can be set to optimally suit the harvest readiness stage of the plants in that growing zone. This adjustment of the climate may have a positive effect in increasing the growing and ripening of the produce, or may slow down the growing and the ripening of the produce.

The settings for the climate in each growing zone may be controlled in a feedback manner. For each of the growing zones, the plant parameters may be determined, for example prior to harvesting. A comparison may be made between the determined plant parameters and a predicted state of the plants, for example on the basis of a model. Should the determined plant parameters lack behind, relative to the predicted state, the climate may be adjusted in an aim to improve the conditions in that growing zone. After another harvesting cycle, it may then be determined if the adjustment of the climate would have had any effect.

In a further embodiment, the climate of the growing zones is adjusted to adjust the growth of the produce. If, for example, a large demand for produce is foreseen, the climate in multiple growing zones may be adjusted temporarily to have more produce ready for harvesting at the moment produce is needed.

Depending on the expected demand, one or more of the growing zones can be filled with more or fewer plants than other growing zones, in order to adjust the number of plants that is subjected to a certain climate, in order to meet the demand.

In an embodiment, only a single group of sorted plants is moved into each growing zone. Each of the growing zones may thereto receive a single group of sorted plants, i.e. different plants at the same or at a similar harvest readiness stage. Should it be desired to scan plant parameters or to harvest produce from plants in a certain group of sorted plants, the entire growing zone may be emptied, to be passed along the scanning device and/or harvesting device. This sorting of plants, having a single group of sorted plants in each of the growing zones may be referred to as ‘inter-section’ sorting of plants.

The inter-section sorting of plants may be beneficial where the climate for the plants is separately adjusted for each of the growing zones. Each of the growing zones contains only a single group of sorted plants during inter-section sorting, which means that the climate conditions for each of the growing zones can be optimized for the plants of that single group.

In an embodiment, the plants are spread at a first spacing distance in the main conveyor section and are spread at a second spacing distance in the secondary conveyor section, wherein the first spacing distance is larger than the second spacing distance.

The present method may offer the flexibility of adjusting the spacing between the plants. Upon travelling inside the central operating area, the plants may be spread relatively wide from each other. This may, for example, improve the quality of scanning of the plant, because the risk of inadvertently scanning another plant is reduced. Furthermore, the harvesting may be done more convenient, because the risk of inadvertent contact with another plant is reduced.

In the cultivation area, once the plants are moved into the growing zone, the plants can be moved closer to each other, to increase the number of plants that can be cultivated per unit of area.

Furthermore, the plants may be spread at further spacing distances in the secondary conveyor section, for example depending on the harvest readiness stage of the group of plants in that secondary conveyor section. As such, the spacing between the plants may be adjusted to the plant's requirements for that respective harvest readiness stage. Accordingly, the plant density, i.e. the number of plants per unit of area, can be adjusted, to optimally use the area of the cultivation area that is available.

According to a second aspect, the present invention provides a cultivation assembly for carrying out the method of cultivating plants as disclosed herein, comprising:
a cultivation area, comprising a plurality of growing zones, configured to receive indeterminate plants to facilitate growing thereof,
a central operating area, having a scanning device for scanning one or more parameters of the plants, and
an overhead conveyor device, extending through the cultivation area and the central operating area, wherein the plants are preferably suspended from the overhead conveyor device in a substantially vertical orientation,
wherein the overhead conveyor device is configured to move the plants between the growing zones and the scanning device,
wherein the overhead conveyor device preferably comprises a sorting device, which is functionally connected to the scanning device and configured to direct a plant to its associated growing zone in dependence of the scanned parameters.

The cultivation assembly according to the second aspect of the invention may have one or more of the features and/or benefits disclosed herein in relation to the method according to the first aspect of the invention, in particular as recited in the appended claims.

The present cultivation assembly is subdivided in the cultivation area, in which the plants are allowed to grow and receive water and/or nutrients, whilst being illuminated, and the central operating area, in which certain interactions with the plants are caried out. Several stationary stations may be arranged in the central operating area to carry out these interactions.

The central operating area at least comprises the scanning device, which is configured to scan one or more parameters of the plants. The plant parameters comprise one or more of a colour of the produce, a texture of the produce, a shape of the produce, a size of the produce, a chemical composition of the produce, in particular a sugar content thereof and/or a fluorescence of the produce, in particular a chlorophyll fluorescence, and/or hyperspectral colour bandwidths thereof.

The cultivation assembly may form part of an indoor faming location, for example a greenhouse. In the following, any reference to an indoor farming location may refer to a greenhouse and any reference to a greenhouse may refer to an indoor farming location.

The overhead conveyor device of the cultivation assembly extends through the cultivation area and the central operating area and along a plurality of growing zones, which growing zones are located in the cultivation area. The overhead conveyor device is configured to move the plants between the growing zones and the scanning device, i.e. between the cultivation area and the central operating area.

According to the present invention, the overhead conveyor device is configured to suspend the plants, which may be any type of device able to transport the plants through the greenhouse. The plants may be suspended directly, for example from their own stem, or may grow in a support structure, like a container supported from the overhead conveyor device. The overhead conveyor device itself may be suspended from a ceiling of the greenhouse.

Preferably, the overhead conveyor device is configured to suspend the plants in a substantially vertical orientation during its entire trajectory through the cultivation area and the central operating area. This may imply that the plants may hang downward from the overhead conveyor device both when the plants are suspended in the cultivation area, when left to grow, and when the plants are moved through the central processing area, i.e. when passing along the scanning device. In this way, the plants will occupy the smallest possible space and may be most convenient to handle.

The cultivation assembly is configured to carry out a method that, as a first step, comprises the step of scanning of one or more parameters of the plants. These plant parameters may provide information about a status of the plant, for example the size of the plant, but especially about the status of the produce of the plants. The plant parameters may for example involve information about the ripeness and/or size of the produce of the plant. The step of scanning is carried out with a scanning device that is arranged in the central operating area, whereas the prior art still relied on scanning, i.e. with a mobile robot, in the cultivation area.

On the basis of the plant parameters, the plants are configured to be characterized into the multiple different harvest readiness stages. This characterization sorts the plants into different groups, for example depending on the ripeness or harvest readiness of the produce. In any case, the harvest readiness stage represents the actual state of the plant relative to a desired state, in which the plant is ready for harvesting.

To this effect, the overhead conveyor device may comprise the sorting device, so that the plants returning from the central operating area can be actively directed into a desired one of the growing zones. The sorting device is associated with the scanning device, to retrieve the scanned parameters from the scanning device. The sorting by the sorting device may then happen on the basis of the scanned parameters, e.g. on the basis of the harvest readiness stage, in order to obtain the sorting of the plants amongst the respective growing zones.

The harvest readiness stage of the plants, in particular the time remaining until produce can be harvested, may be determined on the basis of the heat sum of the plants. The heat sum may be defined as an accumulated time-dependent difference between the actual temperature in the greenhouse and a certain threshold temperature, for example expressed in degrees Celsius. The heat sum may be formed by the daily temperature difference multiplied by the number of days.

After harvesting of the produce, a new heat sum will need to elapse before subsequent produce can be harvested from the same plant. For example, the actual in the greenhouse may be 30° C. and the threshold temperature may be 10° C. Each day thereby contributes 20° C. to the heat sum. Should the heat sum of a certain type of produce for example amount 200° C., then the number of days between harvesting of subsequent pieces of produce will be approximately in the range between 6 and 10 days.

The harvest readiness stages may represent the number of days remaining until the next piece of produce can be harvested. Depending on the type of plants, the harvest readiness stages can span more than a single week, or even less, for example a number of days.

Alternatively or additionally, the harvest readiness stage may be a binary parameter, which may indicate whether or not harvest of produce is required for a certain plant. As such, the present assembly may provide that a plant in need of harvesting can be moved towards a harvesting device and that a plant with produce not ready for harvesting is kept in or moved back into the cultivation area.

After the step of characterizing, the overhead conveyor device may be configured to move the plants towards the cultivation area. However, the plants are not merely moved into the cultivation area in the same order as they are scanned. Instead, the assembly is configured to sort the plants over the multiple growing zones, so that different plants at the same or at a similar harvest readiness stage, end up in the same growing zone. The sorting of the plants may result in a number of groups of sorted plants, that may correspond to the number of growing zones, so that each group of sorted plants is moved into a respective growing zone upon movement into the cultivation area. The number of groups of sorted plants may also differ from the number of growing zones, for example where a single group of sorted plants is moved towards multiple growing zones, or where a single growing zone will receive multiple different groups of plants.

The number of growing zones in the greenhouse may correspond to the total number of harvest readiness stages in which the plants can be characterized. In this case, each growing zone is configured to receive plants that are at a single harvest readiness stage. However, should there be more harvest readiness stages than growing zones, plants with different harvest readiness stages can be grouped in a single growing zone. In case there are, oppositely, more growing zones than harvest readiness stages, multiple growing zones can receive plants that are at the same harvest readiness stage. The latter may be the case with the binary harvest readiness stage, i.e. whether a certain plant is now ready for harvesting or not, so that a relatively large number of plants not ready for harvesting can be held in multiple growing zones and that a relatively small number of plants ready for harvesting can be moved into a single growing zones after sorting.

The growing zones in the cultivation area may, but not need to, be provided in separate compartments in the cultivation area. However, the growing zones may alternatively each be defined as a separate side track of the conveyor device, which side tracks are then all provided in the same cultivation area. Each of the growing zones may have different setpoint values for climate, light, watering and nutrient conditions.

The present cultivation assembly enables that plants can be sorted in different growing zones. In case it is needed to harvest produce from the plants, it is no longer necessary to check the harvest readiness for all plants in the cultivation area, as is the case with the present mobile robots. Instead, only the plants from a certain growing zone, having a certain harvest readiness stage need to be moved towards the harvesting device. The other plants are not yet ripe for harvesting, which means that they can remain in the cultivation area, without being moved. It is known that movement of plants induces stress in the plants, reducing productivity. The present cultivation assembly does not require unnecessary movement of plants that do not need to be harvested, and therefore allows for an improved productivity, and/or a more uniform spacing of the plants over the growing area for optimal light interception and distribution of microclimates.

Furthermore, fewer moving plants implies fewer moving parts of the cultivation assembly, which may give rise to less wear of the assembly. This may reduce downtime and may reduce costs. Additionally, fewer moving plants may also reduce the required average speed in the overhead conveyor device, e.g. the average time that the plants spend outside their growing zones.

The cultivation assembly according to the present invention offers multiple benefits. For example, the plants can be located closer to each other in the cultivation area, since it is no longer mandatory to have robots travelling in between them. This may offer an increased amount of plants per unit of area, and thus allows for improved productivity.

Furthermore, the scanning of plant parameters can also be carried out more accurately, since the plants can be moved away from each other. In the prior art, with the stationary plants, there was a risk that during scanning of plant parameters not only parameters of the intended plant were scanned, but also of other plants. For example, the scanning device could detect ripe produce on another plant and would falsely assign the ripe produce to the wrong plant. According to the present invention, the plants can be isolated from each other, in terms of scanning, to improve the reliability thereof.

Finally, the present cultivation assembly may also allow for exact tracking and tracing of individual plants and their historic plant parameters, coupled to the history of their positions in the growing areas and coupled to the history of plant maintenance operations.

In an embodiment, the scanning device is an optical scanning device, for example a camera device. The optical scanning with the camera may be an efficient manner of determining plant parameters, since images of the produce may contain information about the colour, texture, shape and size of the produce.

The scanning device may further comprise a processing device, configured to process the images to deduct the plant parameters from the images. Hence, the images themselves may only contain the information of the plant parameters implicitly, i.e. as colours and contrasts. By processing of the images, the plant parameters are deducted from the images, to be used for characterization of the harvest readiness stage of the plants.

In an additional or alternative embodiment, the scanning device is oriented in a vertical direction, e.g. comprising a plurality of camera devices arranged above each other. The vertical orientation may allow the scanning device to scan the parameters of the plants over a certain height of the plants, which is convenient when the plants are suspended vertically.

The ripeness of the produce may thereby vary over the height of the plant, for example having the ripe produce located at a bottom portion, whereas the produce further towards the top may not yet be ripe enough for harvesting. With the vertical scanning device, it may be enabled that the plant can be scanned along a substantial part of its height, in order to be able to detect this gradient in produce ripeness.

Preferably, the scanning device may comprise the multiple camera devices above each other, each being configured to scan a respective height portion of the plant, so that the scanned parameters by each of the cameras can be combined into a complete plant parameter.

In an embodiment, the cultivation assembly further comprises a harvesting device arranged in the central operating area for harvesting produce from the plants. The central conveyor device thereby extends between the cultivation area and both the scanning device and the harvesting device. For example, the overhead conveyor device may define a path of conveyance from the cultivation area, to the scanning device, further towards the harvesting device and finally back into the cultivation area.

According to this embodiment, the overhead conveyor device is configured to move plants from a certain growing zone towards the central operating area. The overhead conveyor device may thereto be configured to selectively only retrieve plants from the growing zone of which the predicted growing period has elapsed, without requiring movement of the plants suspended from the overhead conveyor device in the other growing zones.

The overhead conveyor device is, after having moved the plants into the central operating area and along the scanning device, configured to pass the plants along the harvesting device, which is configured to remove the ripened produce from the plants. The harvesting device may further be configured to remove redundant leaves from the plants. The overhead conveyor device is further configured to move the plants back towards the growing zone from which they are obtained, after having passed the harvesting device, to allow them to grow further in the cultivation area and to develop new produce.

The harvesting device may further be configured to remove peduncles, side shoots and petioles, attached to leaves, from the plant stem. The harvesting device may be configured to cut-off all of these that come to face a cutting member of the harvesting device, e.g. to perform a so-called stripping action onto the plant stem. The peduncles, side shoots and petioles sidewardly project away from the plant stem, for example horizontally away from the plant stem, so that they are disposed wider than the plant stem itself.

The harvesting device may comprise a discharge line, configured to remove the harvested produce away from the harvesting device and to pass on the produce for further processing, such as washing, weighing and packaging.

In an embodiment, the cultivation assembly further comprises a lowering device arranged in the central operating area, configured to lower plants by re-suspending the plant by a newly-grown portion of the stem, i.e. above the top portion of the stem. Alternatively or additionally, the cultivation assembly may comprise a human worker station, in which a human worker can be placed to lower the plants.

Additionally, the cultivation assembly may comprise a pruning device arranged in the central operating area, configured to prune the root portion of the plants at least partially at a bottom end thereof. Alternatively, the cultivation assembly may comprise a further human worker station, in which a human worker is placed to prune the root portions of the plants.

The lowering and pruning preferably takes place after harvesting of the produce, i.e. when produce is removed from lowermost portion of the stem. To this effect, the lowering device and/or the pruning device may be placed alongside the overhead conveyor device and downstream of the harvesting device, seen along the path of conveyance.

In the lowering device, the plant is lowered to hold the stem length above the root compartment substantially constant. By lowering, it is meant that the lowering device is configured to change the plant's suspension, so that the plant will come to hang lower. Especially, the lowering device may be configured to release the plant from its original suspension, i.e. in which it was suspended from its original top portion. After release, the lowering device may be configured to lower the plant and to suspend the plant again. However, the plant is now suspended at least partly by its newly-grown portion, i.e. the portion of the plant's stem above the original top portion. As a result, this newly-grown portion then, by definition, becomes the top portion of the stem. It is noted that not the entire plant necessarily becomes suspended by the newly-grown portion, but that the plant may also be suspended by both the newly-grown portion and the original top portion in combination.

The root pruning is carried out to prevent the root portion from becoming too large inside the root compartment. Hence, after lowering, the length of the plant's part inside the root compartment becomes larger. Accordingly, the root pruning may concern the cutting of a bottom portion of the root portion, so that the length of the new root portion is substantially the same as the length of the original root portion, i.e. before lowering.

In an embodiment, the overhead conveyor device comprises a bypass section, which forms a bypass for the section of the overhead conveyor device that passes along the harvesting device, the lowering device and/or the pruning device.

The overhead conveyor device can thereby be set such that the plants, upon travelling through the central operating area, will pass along the scanning device, but that they may not necessarily need to pass the harvesting device, the lowering device, the pruning device and/or other maintenance sections.

The cultivation assembly may be configured to select the path of conveyance for each plant along these sections of the conveyor device on the basis of the plant parameters obtained by scanning of the plants. Should, for example, the plant parameters of a plant indicate that its produce is not yet ready to be harvested, the cultivation assembly may be configured to set the plant's path of conveyance along the bypass, in order not to pass the harvesting device.

In an embodiment, the overhead conveyor device comprises:
a main conveyor section, extending through the cultivation area and the central operating area, i.e. along the scanning device, and
a plurality of secondary conveyor sections in the cultivation area, wherein each of the secondary conveyor sections is arranged at least partially in a growing zone,
wherein each of the secondary conveyor sections is configured to suspend one or more groups of sorted plants.

According to this embodiment, the main conveyor section forms the link between the cultivation area and the central operating area for the plants. The main conveyor section thereby extends along the scanning device, so that the plant parameters can be scanned as the plants move along the main conveyor section, upon travelling along the path of conveyance.

The main conveyor section may also extend along the harvesting device, the lowering device and/or the pruning device. The main conveyor section may thereto comprise a single path of conveyance for the plants along all devices, upon travelling out of the cultivation area and back into the cultivation area.

Alternatively or additionally, the main conveyor section may also comprise the bypass section, so that multiple paths of conveyance may be defined for the plants, for example either passing along the harvesting device or not.

In the cultivation area, the overhead conveyor device comprises the secondary conveyor sections. The secondary conveyor sections extend into the growing zones and are configured to move the plants in and out of the growing zones, since all growing zones are provided with at least one secondary conveyor section.

In addition, the present overhead conveyor device may comprise a ternary conveyor section, which may be functionally arranged in between the main conveyor section and the secondary conveyor sections. As such, the main conveyor section may still extend along all stations, being operative in a relatively complex manner, for example allowing plants to be held stationary in the stations. The secondary conveyor sections may still be configured to store the plants during growth. The ternary conveyor sections may be embodied relatively simple, just serving the purpose to move plants, in order to transfer them between the main conveyor section and the secondary conveyor sections.

The sorting device may be provided in the present embodiment between the main conveyor section and each respective secondary conveyor section, in order to selectively direct a plant from the main conveyor section into a desired one of the secondary conveyor sections. Each secondary conveyor section may thereto be associated with the sorting device, for example each associated with a switching device thereof, i.e. located where the plants are supposed to enter the secondary conveyor section when coming from the central operating area. Each of the switching devices can then be selectively activated to direct the plants into its respective secondary conveyor section.

Alternatively or additionally, the sorting device may be provided between the main conveyor section and each of the one or more buffer sections, in order to selectively direct a plant from the main conveyor section into a desired one of the buffer sections.

In an embodiment, the plants are spread at a first spacing distance in the main conveyor section and are spread at a second spacing distance in the secondary conveyor section, wherein the first spacing distance is larger than the second spacing distance.

The present cultivation assembly, especially where the plants are configured to be moved individually, offers the flexibility of adjusting the spacing between the plants. Upon travelling along the main conveyor section, for example inside the central operating area, the plants may be spread relatively wide from each other. This may, for example, improve the quality of scanning of the plant, because the risk of inadvertently scanning another plant is reduced. Furthermore, the harvesting may be done more convenient, because the risk of inadvertent contact with another plant is reduced. Finally, the increased spacing may also create more space to interact with the plants, for example making harvesting more convenient, which may increase the speed at which interactions with the plants can made.

In the cultivation area, once the plants are moved into the growing zone, the plants can be moved closer to each other, to increase the number of plants that can be cultivated per unit of area.

Furthermore, the plants may be spread at further spacing distances in the secondary conveyor section, for example depending on the harvest readiness stage of the group of plants in that secondary conveyor section. As such, the spacing between the plants may be adjusted to the plant's requirements for that respective harvest readiness stage.

In an embodiment, the overhead conveyor device, preferably the main conveyor section, comprises a plurality of adjacent exchange sections, which define an exchange interface between them. The displacement directions of the plants at the adjacent exchange sections may be aligned opposite to each other.

During use, the adjacent exchange sections may be used for the sorting of the plants, by exchanging plants between the adjacent exchange sections of the overhead conveyor device. As such, the order of suspension of the plants can be changed, so that plants at similar harvest readiness stages can be grouped together.

Especially where the displacement directions are opposite between the adjacent exchange sections, the plants pass each other at the interface. As such, a plant travelling in one direction in a first one of the adjacent exchange sections can be transferred to an empty slot in a second one of the adjacent exchange sections, travelling in an opposite direction.

In an embodiment, each of the growing zones may be provided with a single secondary conveyor section. Each of the secondary conveyor sections may thereto be configured to receive a single group of sorted plants, i.e. different plants at the same or at a similar harvest readiness stage. Should it be desired to scan plant parameters or to harvest produce from plants in a certain group of sorted plants, the entire secondary conveyor section may be emptied into the main conveyor section, to be passed along the scanning device and/or harvesting device. This sorting of plants, having a single group of sorted plants in each of the secondary conveyor sections may be referred to as ‘inter-section’ sorting of plants.

The inter-section sorting of plants may be beneficial where the climate for the plants is separately adjusted for each of the growing zones. Each of the growing zones is configured to contain only a single group of sorted plants during inter-section sorting, which means that the climate conditions for each of the growing zones can be optimized for the plants of that single group.

In an alternative embodiment, each secondary conveyor section is arranged in multiple growing zones. Each of the secondary conveyor sections may thereto be configured to receive multiple groups of sorted plants, to suspend each group in its own intended growing zone. For example, the secondary conveyor sections may each extend through two growing zones, so that each of the secondary conveyor sections can hold two groups of sorted plants.

Should it be desired to scan plant parameters or to harvest produce from plants in a certain group of sorted plants, only part of the entire secondary conveyor section may be emptied, to be passed along the scanning device and/or harvesting device. This sorting of plants, having a single group of sorted plants in each of the secondary conveyor sections may be referred to as ‘intra-section’ sorting of plants.

Preferably, the overhead conveyor device is configured to only move plants of one group of sorted plants in each secondary conveyor section, preferably without moving other plants in that secondary conveyor section. The other plants may remain in place, which may be beneficial in reducing the stresses to which the plants are subjected. Hence, unnecessary movements of plants may result in unnecessary stress for these plants, which could otherwise reduce their productivity.

In an embodiment, the secondary conveyor sections may be embodied as branches of the main conveyor section, for example as straight conveyor sections that project away from the main conveyor section in the cultivation area. These branches may be embodied as linear tracks, having a single connection point with the main conveyor section, i.e. a single switching device per branch, and an opposite dead end. The branches can be filled with plants by moving plants into the growing zone in a first direction, whereas the branches can be discharged by removing plants out of the growing in a second direction, antiparallel to the first direction.

The overhead conveyor device according to this embodiment, having the secondary conveyor sections may be embodied as dead-end branches may be useful when it is desired to sort plants according to the ‘inter-section’ sorting principle.

In an alternative embodiment, the secondary conveyor sections may be embodied as closed-loop conveyor sections, having two opposite ends located alongside the main conveyor section.

These closed-loop conveyor sections may, for example, be embodied as U-shaped tracks, having a two connection points with the main conveyor section. In particular, a first end and an opposed second end of the closed-loop conveyor sections may each be provided with a switching device for the main conveyor section. The closed-loop conveyor section is thereby connectable to the main conveyor section from two ends, allowing the closed-loop conveyor section to be filled with plants from both ends and allowing plants to be discharged from the closed-loop conveyor section from both ends as well.

Alternatively, the closed-loop conveyor sections may be endless conveyors, onto which the plants can be transferred from the main conveyor section. Such endless conveyors may be free of switching devices with the main conveyor section, but may instead each comprise a respective transfer device for transferring plants between the main conveyor section and that closed-loop conveyor section.

The overhead conveyor device according to this embodiment, having the secondary conveyor sections may be embodied as closed-loop conveyor sections, for example U-shaped tracks, which may be useful when it is desired to sort plants according to the ‘intra-section’ sorting principle.

In particular, the closed-loop conveyor sections can be loaded from two sides, i.e. both ends of the closed-loop conveyor sections. This allows multiple groups of sorted plants to be moved or transferred into each closed-loop conveyor section independent of each other. Hence, one of the groups may be loaded from the first end of the closed-loop conveyor section and another one of the groups may be loaded from the second end of the closed-loop conveyor section.

In case it is desired to retrieve the group that was loaded into the closed-loop conveyor section first, it is not needed to first retrieve the group that was loaded second. This would, however, be the case where multiple different groups of sorted plants were to be loaded in a secondary conveyor section embodied as a dead-end branch.

In a further embodiment, the plants in each of the secondary conveyor sections are suspended as respective groups, each holding multiple plants. The groups can be retrieved from their secondary conveyor section to the main conveyor section, and vice versa, in order to move the plants to the central operating area and back into their growing zone. This may be beneficial, since not all plants need to be moved individually, but that all plants in the group can be moved in common instead.

In an embodiment, the overhead conveyor device may comprise one or more transfer devices, configured to transfer plants between the main conveyor section and the secondary conveyor sections, e.g. the closed-loop conveyor sections. Such a transfer device may be configured to temporarily hold one or more plants, in order to remove those plants from the main conveyor section and to attach the plants to a secondary conveyor section, or vice versa.

The transfer device may be movable along the main conveyor section and along multiple secondary conveyor sections, for example all secondary conveyor sections. As such, a single transfer device may be used for multiple secondary conveyor sections, which may reduce the complexity of the overhead conveyor device, in order to reduce costs and to improve efficiency.

In an embodiment, the overhead conveyor device further comprises one or more buffer sections, preferably in the central operating area, configured to temporarily suspend one or more of the plants. The buffer sections may, but not necessarily need to, form a side track of a main path for the plants between the cultivation area and the central operating. As such, the plants can be temporarily stored, for example prior to or after scanning and/or prior to or after harvesting.

The buffer sections serve the purpose of temporarily storing the plants, for example after they are retrieved from the cultivation area and prior to being returned to the cultivation area. The buffer sections can contribute in the sorting of the plants, i.e. after the scanning and the determining of the plant parameters or after the harvesting, by temporarily holding a plant.

The buffer sections may be used to temporarily accumulate plants that are intended to be fed in one of the growing zones. For example, one buffer section may be filled with plants that underwent harvesting, whereas other plants, that did not undergo harvesting, can be returned to the cultivation area directly. The buffer section may be temporarily filled with the plants, until the number of plants corresponds to the intended number of plants for a certain growing zone. Then, the entire buffer section can be emptied to field all plants in the growing zone in one go.

When the buffer section is provided as a side track, the plants can be moved temporarily out of a main path of the plants, for example a main path in the main conveyor section, extending in between the cultivation area and the central processing area. The main path may thereby be formed by the main conveyor section along which the plants are moved between the cultivation area and the scanning device, the scanning device and the harvesting device, and/or between the harvesting device and the cultivation area. By means of the side track, the buffered plants can be moved out of the way of the other plants temporarily so that the other plants can be passed while the buffered plants are bypassed.

In an embodiment, the sorting device comprises at least one switching device for each of the growing zones and a control device, which is functionally connected to the scanning device and to the at least one switching device and which is configured to selectively operate the at least one switching device to direct a plant into a respective growing zone on the basis of the plant parameter obtained from the scanning device

The control device is thereby configured to act on the switching device, so that the plants can be selectively sorted over the growing zones. A switching device may be provided at each of the growing zones, in order to selectively direct a plant into a growing zone. The switching device of each growing zone may be located where the plants are supposed to enter that growing zone when coming from the central operating area.

The control device may receive plant parameters of each of the plants that is scanned in the scanning device and may, for each one of the plants, determine into which of the growing zones that plant is to be moved. To effect this sorting, the control unit may selectively activate the switching device of the desired growing zone, so that the plant can then be directed into that respective growing zone.

### BRIEF DESCRIPTION OF DRAWINGS

Further characteristics of the invention will be explained below, with reference to embodiments, which are displayed in the appended drawings, in which:

FIGS. 1A-1G schematically depict an embodiment of the cultivation assembly according to the present invention,

FIGS. 2A and 2B schematically depict a second embodiment of the cultivation assembly according to the present invention, and

FIGS. 3A and 3B schematically depict a third embodiment of the cultivation assembly according to the present invention.

Throughout the figures, the same reference numerals are used to refer to corresponding components or to components that have a corresponding function.

### DETAILED DESCRIPTION OF EMBODIMENTS

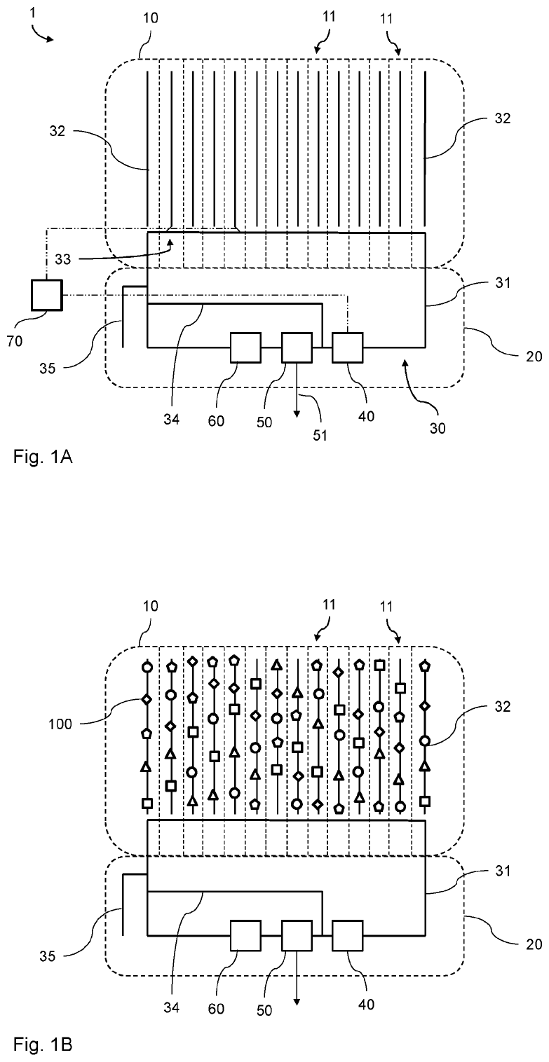

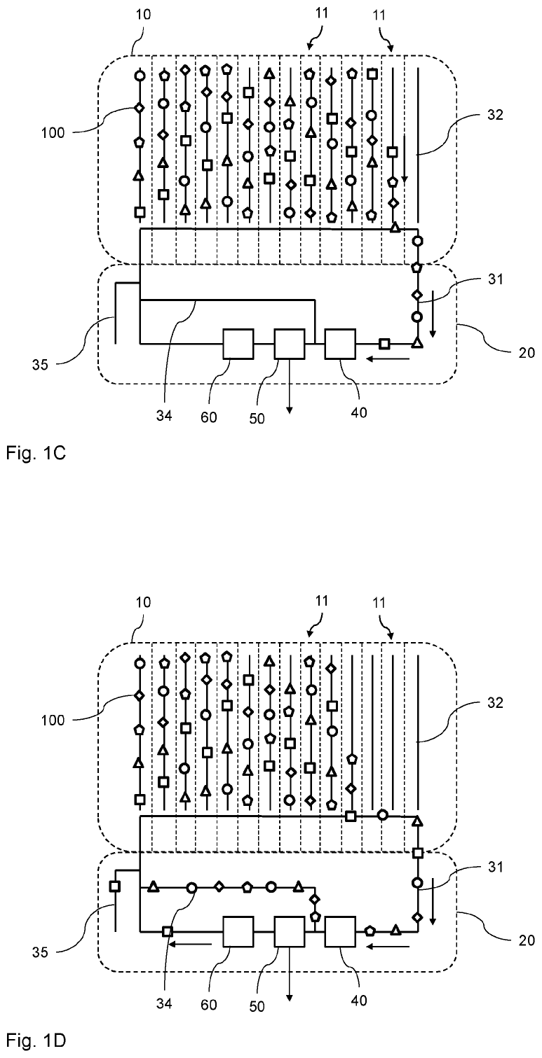

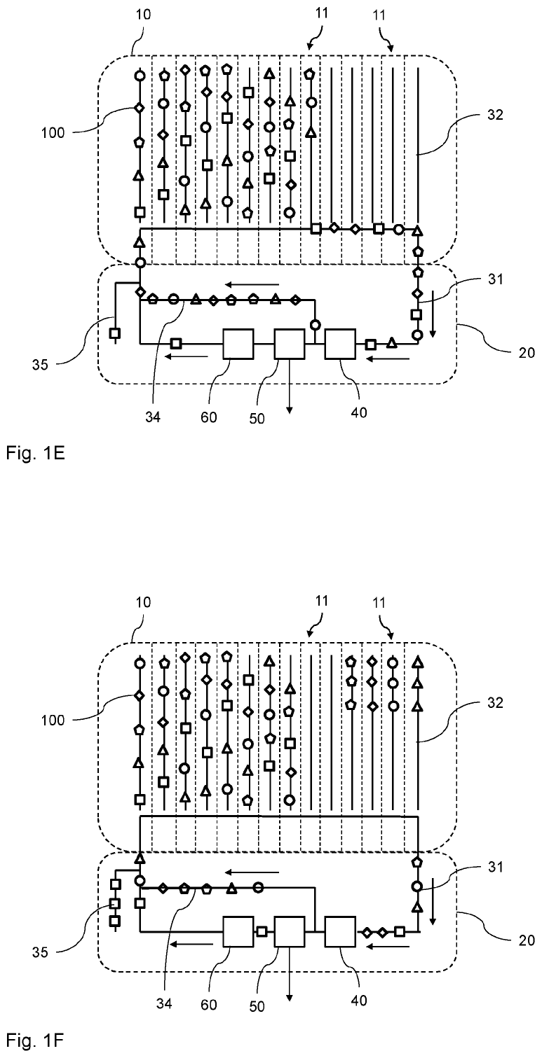

FIG. 1 schematically depicts a first embodiment of the cultivation assembly according to the present invention, to which is referred with reference numeral 1. The cultivation assembly 1 comprises a cultivation area 10 and a central operating area 20. The cultivation assembly 1 forms part of a greenhouse. Both areas 10, 20 form separate compartments of the greenhouse and are indicated schematically in the figures by means of dashed rectangles.

The cultivation assembly 1 is used for the cultivation of indeterminate plants, for example tomato plants, bell pepper plants, cucumber plants and/or eggplants. In the figures, the plants are referred to with reference numeral 100 and schematically displayed as squares, triangles, circles, diamonds and pentagons, depending on their harvest readiness stage.

The cultivation assembly 1 is configured to grow the plants 100 in the cultivation area 10, which is facilitated by the assembly 10 by feeding water and nutrients to the plants 100. The cultivation assembly 10 comprises a plurality of growing zones 11, which are provided in separate compartments in the cultivation area 10. In the figures, the separate compartments are made visible by means of the dashed lines.

The cultivation assembly 1 further comprises an overhead conveyor device 30 that extends through the cultivation area 10 and the central operating area 20, especially along the growing zones 11. The overhead conveyor device 30 is configured to suspend the plants 100 and configured to move the plants 100 between the growing zones 11 and the central operating area 20. The overhead conveyor device 30 is suspended from the ceiling of the greenhouse.

In the central operating area 20, the cultivation assembly 1 is configured to carry out certain interactions with the plants 100. To this effect, several stationary stations are arranged in the central operating area 20 to carry out these interactions. A first example thereof is an optical scanning device 40, which is configured to scan one or more parameters of the plants 100, especially of the produce of the plants 100. The optical scanning device 40 comprises a camera device, for obtaining images of the produce, and a processing device, configured to process the images to deduct the plant parameters from the images. The scanning device 40 is arranged along the overhead conveyor device 30, so that the plants 100 move along the scanning device 40 upon movement with the overhead conveyor device 30.

The plant parameters comprise one or more of a colour of the produce, a texture of the produce, a shape of the produce, a size of the produce, a chemical composition of the produce, in particular a sugar content thereof and/or a fluorescence of the produce, in particular a chlorophyll fluorescence thereof. These plant parameters provide information about a status of the plant 100, especially about the status of the produce of the plants 100. The plant parameters may for example involve information about the ripeness and/or size of the produce of the plant 100.

On the basis of the plant parameters, the plants 100 are configured to be characterized into the multiple different harvest readiness stages. This characterization sorts the plants 100 into different groups 100, for example depending on the ripeness or harvest readiness of the produce. In the figures, each of the groups of plants 100 is represented by a different symbol, i.e. displayed as squares, triangles, circles, diamonds and pentagons. The harvest readiness stages may thereby represent the number of days remaining until the next piece of produce can be harvested.

The cultivation assembly 1 further comprises a harvesting device 50 arranged in the central operating area 20 for harvesting produce from the plants 10. The central conveyor device 30 thereby extends along the harvesting device 50, defining a path of conveyance from the cultivation area 10, to the scanning device 40, further towards the harvesting device 50 and finally back into the cultivation area 10. In the figures, the path of conveyance is shown by means of arrows.

The harvesting device 50 is configured to remove the ripened produce from the plants 100 and further comprises a discharge line 51, configured to remove the harvested produce away from the harvesting device 50 and to pass on the produce for further processing, such as washing, weighing and packaging. The harvesting device 50 is configured to remove peduncles, side shoots and petioles, attached to leaves, from the plant stem.

The cultivation assembly 1 further comprises a lowering and pruning device 60 Arranged in the central operating area 20, configured to lower plants 1 by re-suspending the plant 1 by a newly-grown portion of the stem and to prune a root portion of the plants 100 at least partially at a bottom end thereof. In an alternative embodiment, the cultivation assembly may comprise a human worker station, in which a human worker is placed to lower the plants.

Seen along the path of conveyance, the lowering and pruning takes place after harvesting of the produce. To this effect, the lowering and pruning device 60 is placed alongside the overhead conveyor device 30 and downstream of the harvesting device 50, seen along the path of conveyance. The overhead conveyor device 30 is thereby further configured to move the plants 100 back towards the growing zone 11 from which they are obtained, after having passed the harvesting device 50 and the lowering and pruning device 60, to allow them to grow further in the cultivation area 10 and to develop new produce.

The overhead conveyor device 30 comprises a main conveyor section 31 that extends through the cultivation area 10 and the central operating area 20. The overhead conveyor device 30 further comprises a plurality of secondary conveyor sections 32 in the cultivation area 20, which are each arranged partially in a respective growing zone 11. The main conveyor section 31 thereby forms the link for the plants 100 between the cultivation area 10 and the central operating area 20.

The main conveyor section 31 thereby extends along the scanning device 40, so that the plant parameters can be scanned as the plants move along the main conveyor section 31, upon travelling along the path of conveyance. The main conveyor section 31 also extends along the harvesting device 50 and the lowering and pruning device 60. The main conveyor section 31 thereto provides a path of conveyance for the plants 100 along all devices, upon travelling out of the cultivation area 10 and back into the cultivation area 10.

The main conveyor section 31 has an endless, closed-loop shape, extending both through the cultivation area 10 and the central operating area 20, so that plants 100 can be moved out of the cultivation area 10 and back into the cultivation area 10 on the same conveyor section.

In the cultivation area 10, the overhead conveyor device 30 comprises the secondary conveyor sections 32. The secondary conveyor sections 32 extend into the growing zones 11 and are configured to move the plants 100 in and out of the growing zones 11, since all growing zones 11 are provided with at least one secondary conveyor section 32.

The secondary conveyor sections 32 are selectively connectable to the main conveyor section 31 in the cultivation area 10. As such, the plants 100 may be transferred from the main conveyor section 31 onto a desired one of the secondary conveyor sections 32, to allow the plants to move into a desired growing zone 11, depending on the determined harvest readiness stage. The overhead conveyor device 30 thereto further comprises a switching device 33 for each of the secondary conveyor sections 32, so that all secondary conveyor sections 32 can be selectively connected to the main conveyor section 31 independent of each other. This allows any plant 100 to be moved from the main conveyor section 31 into any of the secondary conveyor sections 32, and vice versa.

The main conveyor section 31 comprises a closed loop rail circulating through the central operating area 20 and the cultivation area 10, i.e. a front end of the cultivation area 10. The secondary conveyor sections 32 are each embodied as rails as well, extending in the cultivation area 10 alone and connectable to the closed loop rail of the main conveyor section 31 via respective switching devices 33.

The overhead conveyor device 30 further comprises a bypass section 34, which forms a bypass for the section of the overhead conveyor device 30 that passes along the harvesting device 40 and the lowering and pruning device 60. With the bypass section 34, the overhead conveyor device 30 can be set such that the plants 10, upon travelling through the central operating area 20, will pass along the scanning device 40, but that they may not necessarily need to pass the harvesting device 40 and the lowering and pruning device 60.

The overhead conveyor device 30 additionally comprises a buffer section 35, located in the central operating area 20 and configured to temporarily suspend one or more of the plants 100. The buffer section 35 serves the purpose of temporarily storing the plants 100, in particular after they are retrieved from the cultivation area 10 and prior to being returned to the cultivation area 10 in the present embodiment. The buffer sections can contribute in the sorting of the plants, i.e. after the scanning and the determining of the plant parameters, by temporarily holding a plant.

In the figures, several configurations of growing zones and secondary conveyor sections are displayed. Amongst these embodiments, similar elements are referred to with the reference numeral, preceded by “100” or “200”.

In the embodiment shown in FIGS. 1A-1G, each of the growing zones 11 is provided with a single secondary conveyor section 32. Each of the secondary conveyor sections 32 is thereby configured to receive a single group of sorted plants 100. The secondary conveyor sections 32 are embodied as straight branches that project away from the main conveyor section 31 in the cultivation area 10. These branches are formed as linear tracks, having a single connection point with the main conveyor section 31, which is shown at the bottom in the figures, and an opposite dead end, shown at the top of the secondary conveyor sections 32. Each of the secondary conveyor sections 32 is provided with a single switching device 33 for selectively connecting and disconnecting the secondary conveyor sections 32 with the main conveyor section 31. The branches can be filled with plants 100 by moving plants into the growing zone in a first direction, e.g. a direction upwards in the figures, whereas the branches can be discharged by removing plants out of the growing in a second direction, antiparallel to the first direction, e.g. a direction downwards in the figures.

Should it be desired to scan plant parameters or to harvest produce from plants 100 in a certain group of sorted plants, the entire secondary conveyor section 32 may be emptied into the main conveyor section 31, to be passed along the scanning device 40 and the harvesting device 50. In the embodiment in FIGS. 1A-1G, the climate for the plants 100 is separately adjusted for each of the growing zones 11. Each of the growing zones 11 is configured to contain only a single group of sorted plants 100, which means that the climate conditions for each of the growing zones 11 can be optimized for the plants 100 of that single group.

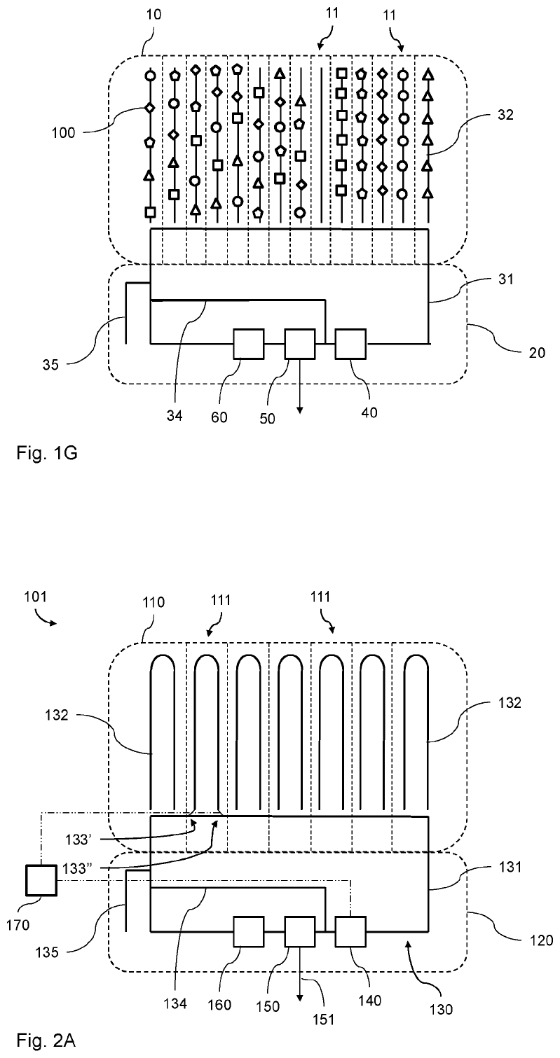

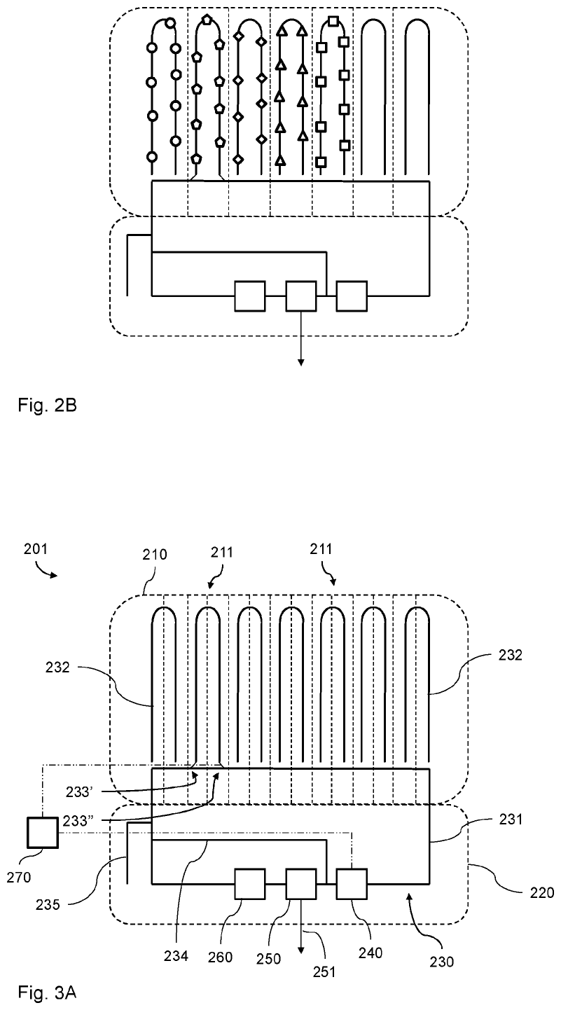

FIGS. 2A and 2B show a different embodiment of the cultivation assembly, to which is referred with reference numeral 101. The cultivation area 110 of this embodiment also comprises a plurality of growing zones 111, represented by the dashed lines in the figures. In this embodiment, the secondary conveyor sections 132 are embodied as closed-loop conveyor sections, having two opposite ends located alongside the main conveyor section 131. The closed-loop conveyor sections 132 are embodied as U-shaped tracks, e.g. inversely U-shaped, having a two connection points with the main conveyor section 131. In particular, a first end of the closed-loop conveyor sections is provided with a first switching device 133′ for the main conveyor section 131 and an opposed second end of the closed-loop conveyor sections 131 is provided with a second switching device 133″ for the main conveyor section 131. The closed-loop conveyor section 132 is thereby connectable to the main conveyor section 131 from two ends, allowing the closed-loop conveyor section 132 to be filled with plants 100 from both ends and allowing plants 100 to be discharged from the closed-loop conveyor section from both ends as well.

This allows multiple groups of sorted plants 100 to be moved into each closed-loop conveyor section 132 independent of each other. Hence, one of the groups may be loaded from the first end of the closed-loop conveyor section 132 via the first switching device 133′ and another one of the groups may be loaded from the second end of the closed-loop conveyor section 132 via the second switching device 133″. In case it is desired to retrieve the group that was loaded into the closed-loop conveyor section 132 first, it is not needed to first retrieve the group that was loaded second. The overhead conveyor device 130 further comprises a bypass section 134, which forms a bypass for the section of the overhead conveyor device 130 that passes along the harvesting device 140 and the lowering and pruning device 160.

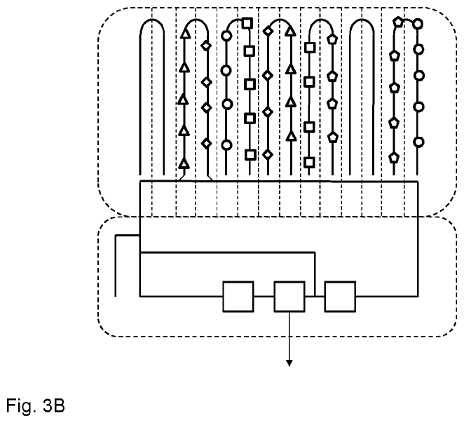

FIGS. 3A and 3B show a further different embodiment of the cultivation assembly, to which is referred with reference numeral 201. The cultivation area 210 of this embodiment also comprises a plurality of growing zones 211, represented by the dashed lines in the figures as well. In this embodiment, the secondary conveyor sections 232 are also embodied as closed-loop conveyor sections, having two opposite ends located alongside the main conveyor section 231. In this embodiment of the cultivation assembly 201, each secondary conveyor section 232 is arranged in two growing zones 211. Each of the secondary conveyor sections 232 is configured to receive two groups of sorted plants 100, to suspend each group in its own intended growing zone 211.

In this embodiment, a first end of the closed-loop conveyor sections is provided with a first switching device 233′ for the main conveyor section 231 and an opposed second end of the closed-loop conveyor sections 231 is provided with a second switching device 233″ for the main conveyor section 231. The overhead conveyor device 230 further comprises a bypass section 234, which forms a bypass for the section of the overhead conveyor device 230 that passes along the harvesting device 240 and the lowering and pruning device 260.

Should it be desired to scan plant parameters or to harvest produce from plants 100 in a certain group of sorted plants 100, only part of the entire secondary conveyor section 232 may be emptied, to be passed along the scanning device 240 and/or harvesting device 250. The overhead conveyor device 230 is configured to only move plants 100 of one group of sorted plants in each secondary conveyor section 232, without moving other plants 100 in that secondary conveyor section 232. In the example shown in the figures, for example only the plants 100 represented with diamonds may be retrieved from the secondary conveyor section 232. The other plants 100, for example the plants 100 represented with triangles, may remain in place, which may be beneficial in reducing the stresses to which the plants 100 are subjected.

Alternatively, however, the assemblies in FIGS. 2A, 2B, 3A and 3B can be configured to receive plants that are suspended from respective strings, each comprising multiple plant suspension attachments for holding a single plant, Each of the secondary conveyor sections can thereby receive a respective string. The strings can be retrieved from their secondary conveyor sections to the main conveyor section in their entirety, and vice versa, in order to move the plants to the central operating area and back into their growing zone.

FIGS. 1B-1G show how the method according to the present invention can be carried out, according to an embodiment thereof. In an initial state, shown in FIG. 1B, the plants are arranged randomly in the greenhouse. In the figures, different plants at different harvest readiness stages are schematically displayed as squares, triangles, circles, diamonds and pentagons.

In FIG. 1C, it is shown that plants in a first one and a second one of the secondary conveyor sections 32 are moved towards the central operating area 10, by means of the main conveyor section 31. Movement of the plants is thereby represented by means of arrows.

It is shown in FIG. 1D that all plants, except for the plants displayed by means of the square, are passed on towards the bypass section after scanning in the scanning station 40. The “square plants” are at a harvest readiness stage that represents that the produce of these plants is ready for harvesting. These plants are therefore passed along the harvesting device 50 for harvesting the produce and along the lowering and pruning device 60 for lowering the plants are for pruning their root portion. After having passed the devices 50, 60, the “square plants” are moved into the buffer section 35.

FIG. 1E shows that other secondary conveyor sections 32 are also emptied, of which the plants are moved towards the central operating area 20. Meanwhile, the already-scanned plants are moved back into the cultivation area 10.

It is shown best in the next step, in FIG. 1F, that the scanned plants are sorted in various different secondary conveyor sections 32 and corresponding different growing zones 11. Hence, all “triangle plants” are sorted in the rightmost growing zone 11, neighboured by the “circle plants”, the “diamond plants”and the “pentagon plants”, seen from right to left.

FIG. 1G, finally, shows that the buffer section 35 with the “square plants” is emptied afterwards. Also these “square plants” are moved into the cultivation area 10 to be sorted in their own growing zone 11.

In all of the embodiments, the cultivation assembly 1, 101, 201 further comprises a sorting device, which is functionally connected to the scanning device 40, 140, 240 and configured to direct a plant 100 to its associated growing zone 11, 111, 211 in dependence of the scanned parameters. The sorting device 40, 140, 240 comprises at least one switching device 31, 131, 231 for each of the growing zones 11, 111, 211 and a control device 70, 170, 270, which is functionally connected to the scanning device 40, 140, 240 and to the switching devices 31, 131, 231 and which is configured to selectively operate the switching devices 31, 131, 231 to direct a plant into a respective growing zone 11, 111, 211 on the basis of the plant parameters obtained from the scanning device 40, 140, 240.

1. A method of cultivating indeterminate plants, for example tomato plants, bell pepper plants, cucumber plants and/or eggplants, that are suspended from an overhead conveyor device, in a cultivation area of an indoor farming location with multiple growing zones, e.g. in a greenhouse, a vertical farm or a climatized warehouse, the method comprising the steps of:
scanning one or more parameters of the plants, e.g. of produce of the plants, with a scanning device arranged in a central operating area of the farming location,
characterizing the plants into multiple different harvest readiness stages on the basis of the scanned parameters,
moving the plants towards the cultivation area, and
sorting of plants into the multiple growing zones on the basis of their harvest readiness stage.

2. The method according to claim 1, wherein the plant parameters comprise one or more of:
a colour of the produce,
a texture of the produce,
a shape of the produce,
a size of the produce,
a chemical composition of the produce, in particular a sugar content thereof,
a fluorescence of the produce, in particular a chlorophyll fluorescence, and/or hyperspectral colour bandwidths thereof, and/or
a plant identifier.

3. The method according to claim wherein the scanning device is an optical scanning device and wherein step of the scanning comprises:
obtaining one or more images of the plants, e.g. of the produce of the plants, and
processing the images to deduct the plant parameters from the images.

4. The method according to claim 1, wherein the plants are sorted in a number of groups, for example corresponding to the number of growing zones, and
wherein each group of sorted plants is moved into a respective growing zone.

5. The method according to claim 1, wherein the harvest readiness stage represents a predicted growing period remaining until at least part of the produce is ripe and/or until harvesting of the at least part of the produce is desired.

6. The method according to claim 5, further comprising, after the predicted growing period of plants in a respective growing zone has elapsed, the steps of:
moving the plants from that growing zone towards the central operating area,
harvesting the at least part of the produce from the plants with a harvesting device arranged in the central operating area, and
moving the plants back towards their growing zone.

7. The method according to claim 5, further comprising, in case the harvest readiness stage of a plant represents that the produce is ripe and/or that harvesting of the at least part of the produce is desired,
moving the plant towards the harvesting device,
harvesting the at least part of the produce from the plants with a harvesting device arranged in the central operating area, and
moving the plants back towards their growing zone.

8. The method according to claim 7, further comprising, after the step of harvesting, the step of accumulating harvested plants,
wherein the moving of the plants comprises moving the accumulated harvested plants towards a single growing zone.

9. The method according to claim 1, further comprising the step of spreading adjacent plants at the scanning device and/or the harvesting device to locally increase a mutual distance between subsequent plants.

10. The method according to claim 1, further comprising the step of adjusting the growth conditions, for example temperature, watering, supply of nutrients and/or lighting conditions, in each of the growing zones in dependence of the harvest readiness stage of the plants in that growing zone.

11. A cultivation assembly for carrying out the method according to claim 1, comprising:
a cultivation area, comprising a plurality of growing zones, configured to receive indeterminate plants to facilitate growing thereof,
a central operating area, having a scanning device for scanning one or more parameters of the plants, and
an overhead conveyor device, extending through the cultivation area and the central operating area, wherein the plants are suspended from the overhead conveyor device in a substantially vertical orientation,
wherein the overhead conveyor device is configured to move the plants between the growing zones and the scanning device, and
wherein the overhead conveyor device further comprises a sorting device, which is functionally connected to the scanning device and configured to direct a plant to its associated growing zone in dependence of the scanned parameters.

12. The cultivation assembly according to claim 11, wherein the scanning device is an optical scanning device, for example a camera device.

13. The cultivation assembly according to claim 11, wherein the overhead conveyor device comprises:
a main conveyor section, extending through the cultivation area and the central operating area, i.e. along the scanning device, and
a plurality of secondary conveyor sections in the cultivation area, wherein each of the secondary conveyor sections is arranged at least partially in a growing zone,
wherein each of the secondary conveyor sections is configured to suspend one or more groups of sorted plants.

14. The cultivation assembly according to claim 11, wherein the overhead conveyor device further comprises one or more buffer sections, preferably in the central operating area, which form a side track of main path for the plants between the cultivation area and the central operating are and which are configured to temporarily suspend one or more of the plants.

15. The cultivation assembly according to claim 11, wherein the sorting device further comprises:
at least one switching device for each of the growing zones, and
a control device, which is functionally connected to the scanning device and to the at least one switching device and which is configured to selectively operate the at least one switching device to direct a plant into a respective growing zone on the basis of the plant parameter obtained from the scanning device.
